(19) United States
(12) Patent Application Publication
(10) Pub. No.: US 2025/0335404 A1
(43) Pub. Date: Oct. 30, 2025

(54) METHOD FOR DATABASE MIGRATION

(71) Applicant: Hewlett Packard Enterprise Development LP, Spring, TX (US)

(72) Inventors: Soumya Ranjan Choudhury, Bangalore (IN); Suresh Madhavarao, Bangalore (IN)

(21) Appl. No.: 18/757,686

(22) Filed: Jun. 28, 2024

(30) Foreign Application Priority Data
Apr. 30, 2024 (IN) 202441034310

(51) Int. Cl. G06F 16/21; G06F 7/16

(52) U.S. Cl. CPC G06F 16/214; G06F 7/16

(57) ABSTRACT

In certain implementations, an export plan is received, from a first database, that comprises instructions executable to create catalog objects of the first database having a relational structure. The export plan may be translated into an import plan for a second database, the import plan comprising multiple import operations and being based on a second syntax that is different from a first syntax of the export plan. The multiple input operations of the import plan may be executed in parallel to generate first import results. The first import results may be filtered and aggregated to generate second import results. The second import results may be merge sorted to generate third import results. The third import results may be imported into the second database, the third import results being consistent with the catalog objects of the first database.

### BACKGROUND

The development of database systems has been marked by the widespread adoption of relational databases (RDBs). RDBs are named for a relational model of data stored and made accessible by such database systems. In a RDB the data is provided in a relational manner that may include a tabular format by using tables having rows and columns. The columns may define the names and data types of variable data fields stored in the table, while the rows may define records or entries of individual data items stored in the table. Furthermore, multiple tables can be used together in one RDB and can be joined to further provide relationships between variable data fields. Relational operators can be used to manipulate or retrieve the data in the tabular format.

### BRIEF DESCRIPTION OF THE DRAWINGS

Aspects of the present disclosure are best understood from the following detailed description when read with the accompanying figures.

FIG. 1 is a depiction of a database migration, in an example.

FIG. 2 is a depiction of a relational schema, in an example.

FIG. 3 is a depiction of a migration agent, in an example.

FIG. 4 is a depiction of a high-performance computing (HPC) cluster, in one example.

FIG. 5 is a depiction of a compute node, in one example.

FIG. 6 is a flowchart of a method of database migration, in an example.

FIG. 7 is a depiction of a compute node, in an example.

Corresponding numerals and symbols in the different figures generally refer to corresponding parts unless otherwise indicated. The figures are drawn to clearly illustrate the relevant aspects of the disclosure and are not necessarily drawn to scale, or perspective.

### DESCRIPTION

The following disclosure provides different examples for implementing different features. Specific examples of components and arrangements are depicted for descriptive clarity in the present disclosure. The present disclosure provides examples that are not intended to be limiting implementations of the subject matter disclosed herein.

Throughout this disclosure, a hyphenated form of a reference numeral refers to a specific instance of an element and the un-hyphenated form of the reference numeral refers to the element generically, or collectively. Thus, as an example (not shown in the drawings), a device “12-1” would refer to an instance of a device class, which may be referred to collectively as devices “12” and any one of which may be referred to generically as a device “12.”

RDBs may be implemented using a relational database management system (RDBMS) that provides storage of RDBs and functional access for using the stored RDBs. As computer technology and networking has evolved, RDBMSs were developed as server systems that can support access to RDBs by a large number of clients. Many RDBMSs have been designed and implemented to support structured query language (SQL) for querying and updating data objects stored by the RDBMS. As a result, SQL became a widespread and common command language for accessing RDBMSs.

The internal structure of a RDB implemented using a RDBMS supporting SQL, also simply referred to as a “SQL database” (e.g., for a RDB) or a “SQL database system” (e.g., for a RDBMS), may be defined by a so-called “schema” that includes details of data objects stored and their relationship to each other. As used herein, a “table” refers to an orthogonal data structure having rows and columns of individual data elements. The “columns” of a table generally define different data fields, which may be of specified data types, such as integer, numeric, text, enumerated lists, etc. The “rows” in a table refer to a data entry that can include one element for each column in the table. An individual row in a table is also referred to as a “record”. As used herein, a “join relationship” or simply a “join” refers to a join operation between elements shared between two tables in a database. For example, sharing the same values in a particular column by records in two tables, and relating these values to the corresponding records in each table, describes a join. Such records (or their respective tables) are said to be “joined” or share a join relationship.

In a SQL database, the stored data objects may include tables that have specific columns having unique record values for indexing the records in a table, also referred to as “indexes”, “index values”, or “keys.” The index values may be used to define relationships between tables, and also to define and enforce integrity constraints for the relationships that together are described in a formal definition of the schema. The integrity constraints may help ensure compatibility and proper intended operation of the SQL database according to the schema.

SQL databases (or SQL database systems) may comply with a certain set of properties, namely atomicity, consistency, isolation, and/or durability, collectively referred to as ACID. SQL database systems have been widely used as desktop and mobile computing evolved through the 1990s. With the advent of the Internet, and particularly with the arrival of so-called “Web 2.0” after the year 2000 that ushered in the age of interactive websites and the promulgation of user-generated content on social media platforms, the computational demands on database systems began to change and move away from SQL database systems, such as for certain big data and real-time web applications. For many such Web 2.0 applications that today are a large portion of online systems, the formalized structure of SQL database systems were increasingly found by developers to be relatively complex to design, difficult to scale in performance, and unwieldy to control for availability and performance.

Furthermore, as object-oriented programming environments became more widely used, a so-called object-relational mismatch (or object-relational impedance mismatch) was observed as certain difficulties in transferring and translating data and digital content between object model-based applications and typical SQL database systems used as data repositories for such applications. In part, the object-relational mismatch may result from a potential mismatch between newer object model-based data structures and the formal data structures used in SQL databases that were carried over from legacy applications.

Non-relational databases, also referred to as “NoSQL databases”, may provide an alternative to SQL database systems, such as for large data repositories (e.g., big data) and/or online applications that involve low latency and high data throughput, sometimes referred to as “real-time” applications. Characteristics of NoSQL databases can include high availability, a distributed architecture, horizontal scaling, and a flexible data model. Example NoSQL databases may include columnar databases (Apache Cassandra, Amazon Redshift, Clickhouse), spatial databases (PostGIS, Oracle Spatial, Server Spatial), object-oriented databases (db40, Versant, ObjectDB), key-value databases (Redis, AWS DynamoDB, Apache Hbase), graph databases (Neo4j, AWS Neptune, JanusGraph), document databases (MongoDB, Couchbase, AWS DynamoDB), and time series databases (InfluxDB, TimescaleDB, AWS Timestream), among other examples.

Various implementations of NoSQL databases may use one primary data structure instead of the relational data storage in SQL databases. Accordingly, NoSQL databases may be used without a schema and are often tailored for one particular type of data object. NoSQL databases can provide a good ability to scale and can manage large data volumes that can include unstructured data objects. While NoSQL databases can also have certain disadvantages or can lack certain attributes of SQL databases, for applications involving large data volumes of a particular data type, NoSQL databases have increased in popularity.

As a result of the promulgation of NoSQL databases, a concurrent demand for migration solutions to migrate the contents of a SQL database to a NoSQL database has also increased. Database migration is a process of transferring existing structures and data from one or more source databases to one or more target databases. In many cases, database migration may be performed using a database migration service. When a database migration is complete, the existing data in the source databases resides, though possibly restructured, in the target database.

With the emergence of cloud solution providers that provide various solutions for database migration across databases, database owners can procure database migration services based on their business needs, cost effectiveness, among other factors. Because large database systems can be used in long lifecycles, many legacy SQL database systems have continued operation, even while various other aspects of computer and network technology have rapidly developed. Thus, owners of many legacy SQL database systems have found that migration to a NoSQL database system is desirable. An expectation for an economically feasible database migration is that the target database can operate in a manner that gives consistent results as with the source database.

While various solutions may exist for different types of database migration, specific solutions for database migration have often been constrained to a particular types of database, and in particular, to SQL databases. Furthermore, some typical migration solutions can be complex and be prone to introducing new errors in data consistency, which is also undesirable. For example, some typical migration solutions can involve recreation of the schema of the source database, which can be error prone, risky, and expensive. Certain typical migration solutions may be limited to the types of target databases supported, with can constrain applicability in an undesirable manner.

Furthermore, database migration can involve two major steps or phases. A first step can involve migration of the structures and associated data objects in the source database, also referred to as “catalog objects”, to the target database. Then, in a second step, the actual bulk data, such as in the form of records in various tables, can be transferred to the target database, after the first step is complete and corresponding catalog objects to the source database have been created in the target database. Thus, in the first step, the target database can be populated with structure objects that correspond to the catalog objects in the source database, but are in native format, such as a given NoSQL format. Then, in the second step, the target database can be populated with the bulk data of the source database, once the structure objects have been created to contain the bulk data, in consistency with the catalog objects of the source database.

A method and system for database migration from a source database that is a SQL database to a target database that is a NoSQL database is described herein. The method and system for database migration may involve migration of the catalog objects in the source database to corresponding structure objects in the target database, while transfer of the bulk data from the source database to the target database can be performed in a subsequent step. The source database may be scanned using tools associated with a source database system, such as a SQL database system, to compile an export plan for the source database. The export plan may include various SQL statements that can be used to recreate the catalog objects of the source database.

The export plan can be received by a migration agent that can use a first application programming interface (API) to convert the SQL statements in the export plan to statements in a format that is supported by the target database. For example, the first API can be customized to support a syntax for one or more target databases, respectively. The output of the first API may include an import plan for the target database that is compatible with the language and syntax of the target database. For example, the first API may convert (or translate) the catalog objects of the source database into corresponding structure objects of the target database.

The migration agent can further use a second API to receive the import plan and to execute the import plan on the target database to create the structure objects in the import plan. The structure objects that the second API may import into the target database can include unique values for indexes (also referred to as keys) associated with tables, along with joins (or an equivalent structure compatible with the target database) for certain ranges of index values that correspond to the join relationships among tables in the export plan.

In particular instances where the database migration is performed on large and complex databases, such as SQL databases having large numbers of catalog objects, the second API may divide import operations associated with the import plan into multiple parallel tasks for parallel execution. The parallelization of the import operations by the second API may serve to improve performance of the migration agent by providing parallel execution, such as by multiple instances of the second API that run substantially simultaneously. For example, the second API may divide the import operations into subsets of ranges of the index values, such that the subsets are executed in parallel or substantially in parallel. After the second API has performed the import operations, the results may be filtered and aggregated, along with merge sorting, before being imported into the target database.

After the catalog objects from the source database have been imported by the migration agent into structure objects compatible with the target database in this manner, the catalog objects can be considered to be consistently replicated in the target database. Then, in a subsequent step, the bulk contents of the source database can be transferred to the target database, while maintaining consistency in outputting correct results to queries sent to the target database, to replicate the correct results to the same or corresponding queries sent to the source database.

According to certain implementations of this disclosure, a method for database migration provides the ability to migrate from a SQL database system to a NoSQL database system. Certain implementations can provide for automated database migration while maintaining data consistency. Certain implementations can be suitable for migrating databases storing a large or a very large set of catalog objects in the source database. Certain implementations can perform importation based on structure objects for the target database translated from the catalog objects in a parallel manner for improved performance. Certain implementations can provide the same results to queries from the target database as were provided by the source database. Certain implementations can rely on reading and interpreting the schema of the source database to translate the catalog objects into the structure objects without having to implement a new schema, such as structure objects for NoSQL database systems that do not support relational schema. Certain implementations can support migration to various different types of target NoSQL database systems in consistency with a source SQL database system.

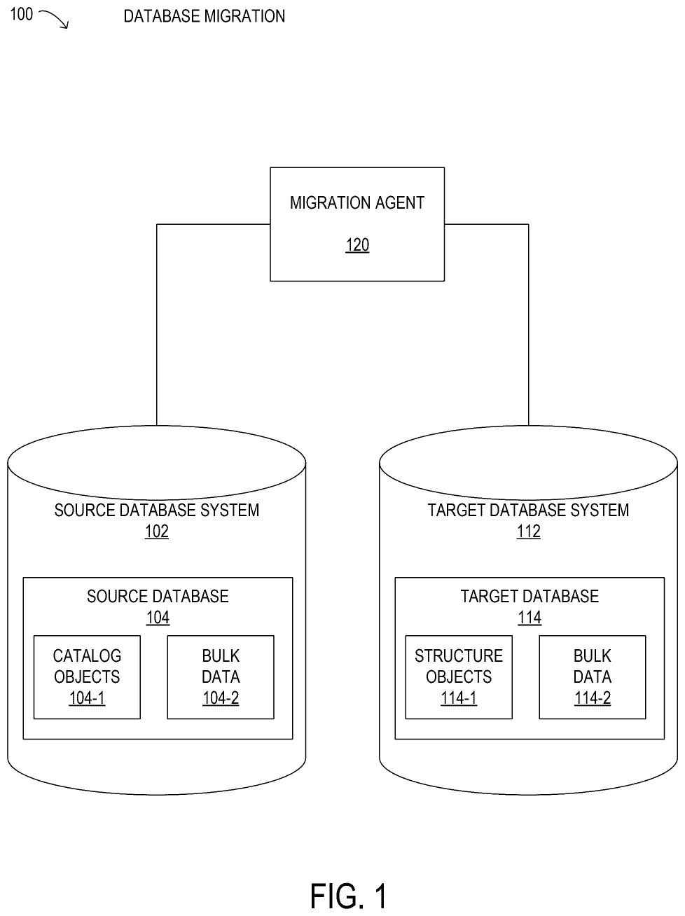

Turning now to the drawings, FIG. 1 is a depiction of a database migration 100, in an example. FIG. 1 is a schematic illustration and depicts certain data structures and processing operations associated with database migration 100.

As shown in FIG. 1, database migration 100 is performed from a source database system 102 using a migration agent 120 to a target database system 112. Source database system 102 and target database system 112 can represent a variety of database applications that include various functionality and features, and can be used to instantiate and operate one or more databases. In particular, source database system 102 may be a RDBMS and may accordingly support SQL for various database operations. Target database system 112 may also be another database application that can have similar scope and functionality as source database system 102. In contrast to source database system 102, target database system 112 may be a NoSQL database system that may handle data in a non-relational manner and may operate with a different structure than by using a schema of source database system 102.

For example, database applications, such as source database system 102 and target database system 112, may be implemented using a network server and may support connections to multiple clients, such as a large number or a very large number of clients. The database applications may use a dedicated form of data storage that is optimized for the types of transactions that the database applications perform, and that is encapsulated and managed by the database applications. The database applications may have dedicated working memory that is allocated for exclusive use by the database applications.

In FIG. 1, source database system 102 is shown storing a source database 104 that represents one of multiple databases that source database system can instantiate and operate. Source database 104 is shown including catalog objects 104-1 and bulk data 104-2. As noted, catalog objects 104-1 can encompass various structures and associated data objects in source database 104, such as structures and associated data objects compatible with SQL databases. Specifically, catalog objects 104-1 can include a catalog, one or more schema, tables, views, stored procedures, sequences, functions, and triggers, among others.

Among the catalog objects 104-1, the catalog can include certain detailed information, also referred to as descriptor information or metadata, regarding the various data objects forming certain structures in source database 104. In SQL databases, the catalog can be referred to as “information_schema” that includes information about the one or more schema in source database 104. Accordingly, a hierarchical relationship between the catalog, schema, and tables implemented in source database 104 can be expressed in order as: catalog→schema→table.

The views included with catalog objects 104-1 can represent so-called “virtual tables” that can contain a subset of one or more tables joined together as a single virtual table. Views may be used for viewing or accessing data and may simplify certain SQL operations, in various implementations. Also included with catalog objects 104-1 are stored procedures that can include executable code, such as in the form of one or more SQL statements along with other programming code. For example, stored procedures can be created and stored, and then later invoked for execution, such as by invoking a procedure name that is unique within source database 104. In this manner, certain operations or groups of operations that are often repeated can be invoked for execution in a simpler, collective manner as a stored procedure.

The sequences included with catalog objects 104-1 can be certain sequences of values stored in one or more tables of source database 104. For example, the sequences can be sequences of index values for particular tables, such as to represent a certain range of associated records that are grouped together. For example, sequences can be stored and invoked, such as for execution of certain SQL statements over the index values in the sequence.

The functions included with catalog objects 104-1 can be similar to the stored procedures and can be included in a stored procedure. A function is a parameterized type of logic that can have at least one input value and can typically return one output value. Functions typically are limited to querying data and do not modify contents of source database 104. Functions are also typically prevented from calling a stored procedure. A trigger is another type of logic included with catalog objects 104-1 that is automatically invoked by a data event or a logical condition, rather than being explicitly called, such as by a SQL statement.

Thus, catalog objects 104-1 may include various structures and functionality that together define the structure and operation of source database 104. Catalog objects 104-1 by themselves may exclude the actual data (e.g., records) that populates source database 104, which is represented by bulk data 104-2.

In FIG. 1, migration agent 120 can be configured to convert or translate catalog objects 104-1 that are compatible with SQL into structure objects 114-1 included with target database 114, as described herein. Since target database 114 may be a NoSQL database, structure objects 114-1 may be compatible with the data architecture and data types supported by target database 114. Specifically, structure objects 114-1 may be consistent with catalog objects 104-1, such as by providing consistent results to a corresponding query sent to either source database 104 or target database 114.

After migration agent 120 has implemented or created structure objects 114-1 in target database 114, bulk data 104-2 can be populated into bulk data 114-2 in database migration 100. In particular implementations, a different migration tool than migration agent 120 may be used for migrating bulk data 104-2 into bulk data 114-2, such as a commercially available migration tool or service. In some implementations, migration agent 120 may also be capable of migrating bulk data 104-2 into bulk data 114-2, such as in a subsequent step to creating structure objects 114-1 from catalog objects 104-1 in database migration 100. In particular implementations, migrating bulk data 104-2 into bulk data 114-2 may involve certain data operations for data translation or conversion, such as for certain data types that are included with source database 104 but are not available or not directly supported in target database 114, for example. Thus, in particular implementations, the migration tool or service, or migration agent 120, may be capable of the data translation or conversion involved with migrating bulk data 104-2 into bulk data 114-2.

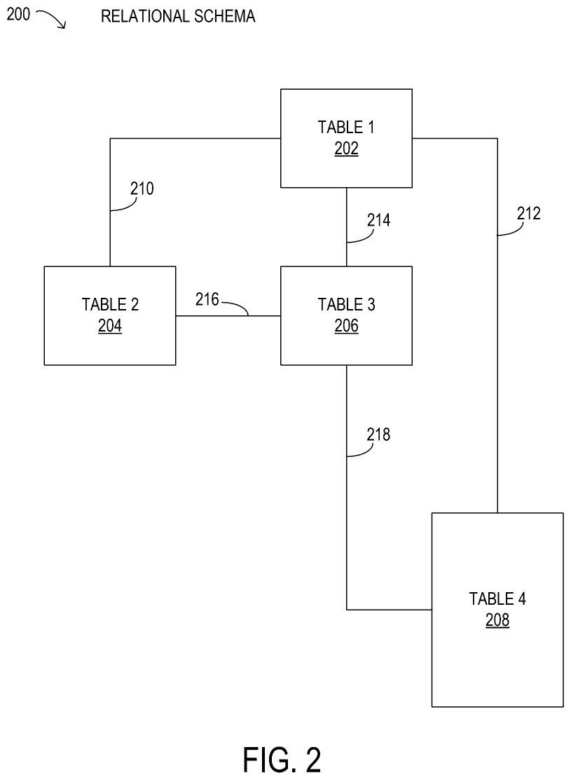

FIG. 2 is a depiction of a relational schema 200. In general, relational schema 200 illustrates relationships between tables in a relational database, such as in source database 104, and may be represented, at least in part by catalog objects 104-1 (see FIG. 1). Relational schema 200 shows an exemplary implementation that can represent different database schema of various complexity, scope, and size.

As shown in FIG. 2, relational schema 200 includes four tables, table 1 202, table 2 204, table 3 206, and table 4 208 and five joins 210, 212, 214, 216, 218 between individual tables. Relational schema 200 may specify that table 1 202 is related to table 2 204 by join 210; table 1 202 is related to table 4 208 by join 212; table 1 202 is related to table 3 206 by join 214; table 2 204 is related to table 3 206 by join 216; and table 3 206 is related to table 4 208 by join 218.

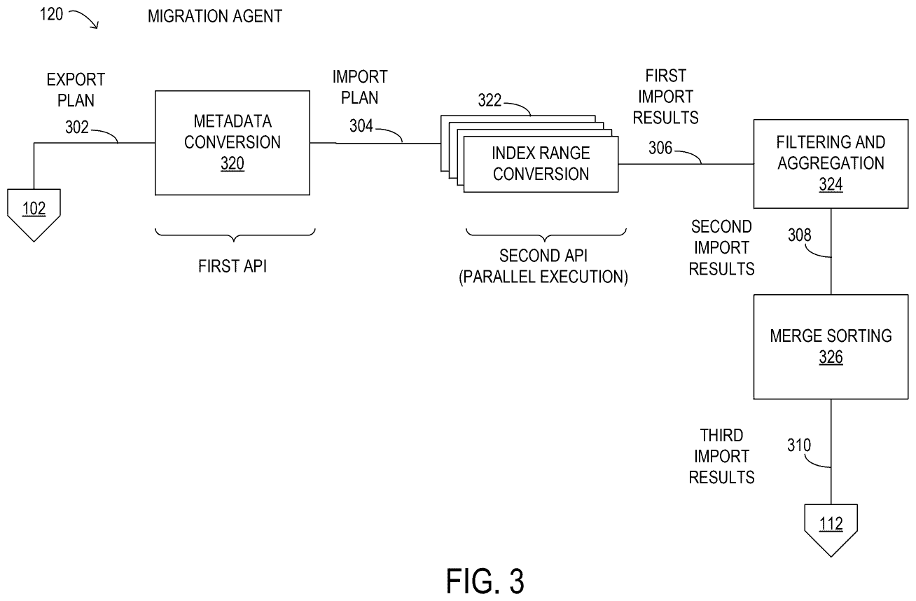

Accordingly, relational schema 200 may include certain catalog objects 104-1 that are described in a relational structure to each other. When relational schema 200 describes a SQL relational database, relational schema 200 can be described, such as for export purposes, by one or more SQL statements that can be executed to create the catalog objects shown in relational schema 200 (see also export plan 302 in FIG. 3), among other catalog objects. Various other catalog objects besides relational schema 200 itself, as noted above, may also be described with one or more SQL statements that can be executed to create (e.g., for export and migration) the other catalog objects, in a similar manner, such as the catalog, additional schema, additional tables, views, stored procedures, sequences, functions, and triggers, among others.

As noted, migration agent 120 is capable of migrating catalog objects 104-1 that are compatible with SQL into structure objects 114-1 that may be compatible with various NoSQL implementations that do not support relational schema, such as relational schema 200. Migration agent 120 can accordingly convert or translate relational schema 200 into a corresponding data structure included with structure objects 114-1 that are compatible with a given NoSQL implementation supported by target database 114.

FIG. 3 is a depiction of migration agent 120, in an example. In particular implementations, migration agent 120 may include different or other elements than shown in FIG. 3. FIG. 3 is a schematic illustration that describes various data operations involved with migrating catalog objects 104-1 into structure objects 114-2, as noted. As shown in FIG. 3, migration agent 120 include various functional elements that can represent programming code or logic circuitry in different implementations, such as a metadata conversion 320, an index range conversion 322, a filtering and aggregation 324, and a merge sorting 326. In various implementations, metadata conversion 320 may be provided in the form the first API, while the index range conversion 322 can be provided in the form of the second API.

In FIG. 3, migration agent 120 may receive an export plan 302 from source database system 102 (see FIG. 1). As noted, export plan 302 may include various SQL statements that can be used to define, or recreate, catalog objects 104-1 of source database 104, such as shown and described above for database migration 100. To generate export plan 302, source database 104 may be scanned using tools associated with, or included with, source database system 102 to compile export plan 302. For example, source database system 102 may include a compiler for performing a compilation process to generate export plan 302 for source database 104, also referred to as “scanning” source database 104. In some implementations, an compilation tool or system external to source database system 102 may be used for scanning.

In a first phase of scanning, the compilation process may parse one or more SQL statements and the compiler may include a parser, a binder, and a normalizer to perform the first phase. In a second phase of scanning, the compilation process may compile the output of the first phase and the compiler may include an optimizer, a precode generator, and a generator to perform the second phase. The optimizer may generate one or more scanning plans and may select one scanning plan as being optimal (e.g., provide results with optimal computation effort). Once the scanning plan is determined, an executor may execute the scanning plan to generate export plan 302.

Then, export plan 302 may be received by metadata conversion 320 that can be implemented as the first API to convert the SQL statements in the export plan 302 to an import plan 304 that includes statements in a format supported by target database system 112. For example, the first API can be customized to support a syntax for one or more types of target databases 114, respectively. In particular implementations, the syntax for target database 114 may be implemented using extensible markup language (XML) or Java script object notation (JSON), among other examples.

Table 1 shows one example of a conversion or translation between SQL syntax and a corresponding XML syntax.

TABLE 1
Example translation from SQL syntax to XML syntax

| SQL Syntax | XML Syntax NoSQL |
|---|---|
| SELECT COLUMN1, SUM(COLUMN2) | <table name=“TABLE1”> |
| FROM TABLE1 | <pkColumns> |
| WHERE COLUMN3=? | <pkColumn> |
| AND COLUMN4 >=? | <column name=“COLUMN3” |
| AND COLUMN4 <=? | sqlType=“CHAR” |
| GROUP BY COLUMN1; | maxLength=“15”/> |
| | </pkColumn> |
| | <pkColumn> |
| | <column name=“COLUMN1” |
| | sqlType=“CHAR” maxLength=“1”/> |
| | </pkColumn> |
| | <pkColumn> |
| | <column name=“COLUMN4” |
| | sqlType=“COLUMN4” maxLength=“8”/> |
| | </pkColumn> |
| | </pkColumns> |
| | <columnFamilies> |
| | <columnFamily name=“1”> |
| | <column name=“COLUMN2” |
| | sqlType=“INTEGER” |
| | nullable=“true”/> |
| | <column name=“COLUMN5” |
| | sqlType=“INTEGER” |
| | nullable=“true”/> |
| | <column name=“COLUMN6” |
| | sqlType=“INTEGER” |
| | nullable=“true”/> |
| | </columnFamilies> |
| | </table> |

Table 2 shows one example of a conversion or translation between SQL syntax and a corresponding JSON syntax.

TABLE 2
Example translation from SQL syntax to JSON syntax

| SQL Syntax | JSON Syntax NoSQL |
|---|---|
| CREATE TABLE TABLE1 ( | { |
| COLUMN1 VARCHAR(20) NOT | TableName : “TABLE1”, |
| NULL, | KeySchema: [ |
| COLUMN2 VARCHAR(30) NOT | { |
| NULL, | AttributeName: “COLUMN1”, |
| COLUMN3 VARCHAR(25), | KeyType: “HASH” //Partition key |
| COLUMN4 INT, | }, |
| COLUMN5 FLOAT, | { |
| COLUMN6 VARCHAR(10), | AttributeName: “COLUMN2”, |
| COLUMN7 TEXT, | KeyType: “RANGE” //Sort key |
| PRIMARY KEY(COLUMN1, | } |
| COLUMN2) | ], |
| ); | AttributeDefinitions: [ |
| | { |
| | AttributeName: “COLUMN1”, |
| | Attribute Type: “S” |
| | }, |
| | { |
| | AttributeName: “COLUMN2”, |
| | Attribute Type: “S” |
| | } |
| | ], |
| | ProvisionedThroughput: { // Only |
| | specified if using provisioned mode |
| | ReadCapacityUnits: 1, |
| | WriteCapacityUnits: 1 |
| | } |
| | } |

Thus, an output of metadata conversion 320 (e.g., the first API) may include import plan 304 that is compatible with the language and syntax of target database system 112. In particular, the first API may convert (or translate) catalog objects 104-1 from export plan 302 into corresponding representations of structure objects 114-1 in import plan 304. In particular implementations, metadata conversion 320 may convert various catalog objects 104-1, such as defined by a schema for source database 104, into import plan 304.

Import plan 304 may include representations of structure objects 114-1 as unjoined data objects for subsequent processing in migration agent 120. Accordingly, Import plan 304 may be populated without various index values associated with tables included in the schema for source database 104. In particular implementations, source database 104 may be a very large database, such as having multiple thousands of tables that may collectively store multiple millions of records. As a result, the population of such large numbers of index values into respective large numbers of tables may be performed by the second API that supports parallel execution for improved performance for populating the index values.

Thus, import plan 304 may be received from metadata conversion 320 by index range conversion 322 that is performed by the second API. In index range conversion 322, various index value ranges may be divided into subsets representing certain tables specified in export plan 302, or portions of individual tables specified in export plan 302. Then, the second API may implement parallel execution of index range conversion 322 for import operations associated with each of the subsets, resulting in parallel execution of multiple import operations (in addition to the multiple import operations previously performed by metadata conversion 320 for the metadata).

The result of index range conversion 322 using the second API are first import results 306 that are populated with index values and, therefore, may be joined, such as according to the join relationships among tables in export plan 302. However, first import results 306, due to the conversion from export plan 302 from a relational format to a non-relational format, may still include duplicate values and may still be segmented according to the subsets used for parallel execution that may generate parallel segmented results.

First import results 306 are then received by filtering and aggregation 324. Filtering and aggregation 324 in migration agent 120 may eliminate duplicate or redundant index values and may concatenate certain subset index values, where appropriate to generate second import results 308. Then, second import results 308 may be received by merge sorting 326 that may merge sort data objects in second import results 308, now in the form of structured objects 114-1, to output third import results 310. In a final operation, migration agent 120 can use third import results 310 to create structured objects 114-1 on target database 114 (by accessing target database system 112) that are consistent with catalog objects 104-1 of source database 104.

As noted, after migration agent 120 has created catalog objects 104-1, bulk data 104-2 can be migrated to bulk data 114-2 to complete migration of source database 104 to target database 114, such that target database 114 is functionally consistent with source database 104 with respect to catalog objects 104-2 and bulk data 104-2.

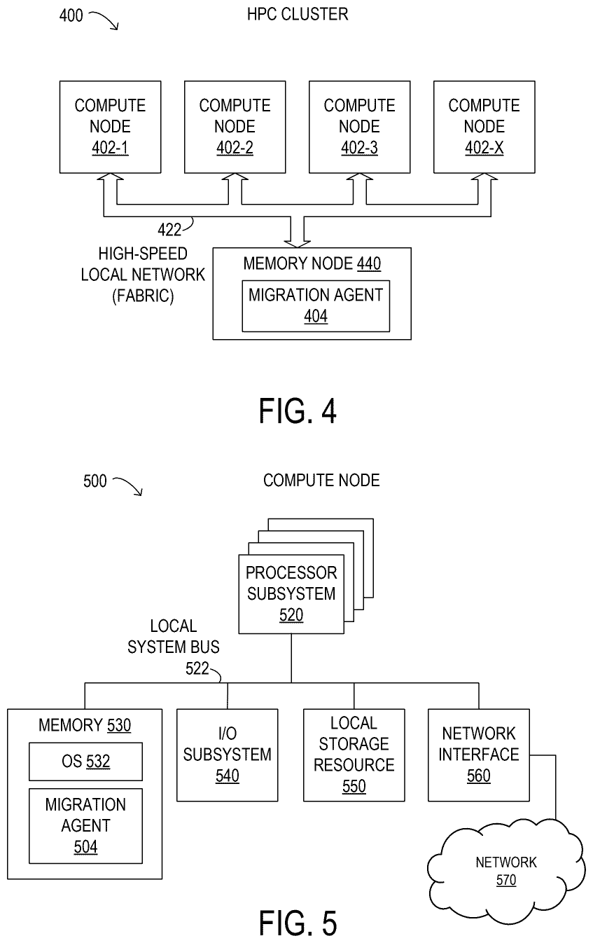

FIG. 4 is a depiction of an HPC cluster 400, in one implementation. FIG. 4 illustrates a schematic block diagram depiction of HPC cluster 400, in accordance with one or more implementations of this disclosure. Implementations described herein may be implemented using an HPC cluster, such as HPC cluster 400 shown including multiple compute nodes 402 (see also compute node 500 in FIG. 5). Although four compute nodes 402-1, 402-2, 402-3, 402-4 are shown in FIG. 4, any number of compute nodes 402 may be used. In particular implementations, a large number of compute nodes 402 may be aggregated in HPC cluster 400 to provide greater computing capacity, and may be used to implement a supercomputer in some implementations. Accordingly, workloads, such as involved with a migration agent 404 that represents at least certain portions of of migration agent 120, described above with respect to FIGS. 1 and 3, may be executed in a distributed manner in HPC cluster 400, e.g., by implementing multi-node application execution, such that compute nodes 402 share processing of the workload that may be performed in a parallel or simultaneous manner among compute nodes 402. For example, index range conversion 322 as implemented by the second API may be performed in a parallel or simultaneous manner among compute nodes 402 in particular implementations.

HPC cluster 400 can be described in general terms as a collection of computing nodes 402 that respectively include a local processor and local memory, and are interconnected by a dedicated high-bandwidth low-latency network, shown as high-speed local network 422 in FIG. 4. HPC cluster 400 can accordingly aggregate and combine the computational power of multiple computing nodes 402 to perform large-scale workloads. HPC cluster 400 can provide flexibility and scalability of HPC resources so that computing power can be well matched to current and evolving workload needs, in an economical and seamless manner. HPC cluster 400 can also provide great flexibility of cluster configuration to handle task parallelization, data distribution, parallel execution, cluster monitoring and control, as well as combining the output of parallelized computations. Applications can execute on HPC cluster 400 in a local or distributed manner, such as on a single HPC compute node 402-1 or on multiple HPC compute nodes 402-2, 402-3, 402-4.

As shown in FIG. 4, HPC cluster 400 includes a memory node 440, which may represent a storage appliance that is compatible with high-speed local network 422. As shown, memory node 440 can host migration agent 404, along with associated data. High-speed local network 422 may be referred to as a “fabric” and may be a dedicated local bus such as Slingshot, InfiniBand, 40 Gb Ethernet, or peripheral connect interface express (PCIe), among others. Accordingly, memory node 440 can provide access to storage resources using low latency high-speed local network 422 to support HPC workloads processed using HPC cluster 400. HPC cluster 400 may include a dedicated network interface that can provide network connectivity, such as by using compute node 402.

FIG. 5 is a depiction of a compute node 500, in one example. FIG. 5 illustrates a schematic block diagram depiction of compute node 500, in accordance with one or more implementations of this disclosure, that may represent compute node 402 in FIG. 4. Implementations described herein may be implemented using compute nodes, such as compute node 500, in an individual manner or in a cluster of multiple compute nodes, such as HPC cluster 400 that includes multiple compute nodes 402, as described above with respect to FIG. 4. Accordingly, compute node 500 may represent any of a variety of computer systems or computing devices, such as personal computers, desktop computers, laptops, servers, blade computers, modular computers, and HPC compute nodes, among others.

As shown in FIG. 5, compute node 500 includes a processor subsystem 520, a memory 530, a local storage resource 550, a network interface 560, an input/output (I/O) subsystem 540, and a local system bus 522 for interconnecting various local elements with processor subsystem 520. Network interface 560 may provide connection to a network 570, described in further detail below.

As shown in FIG. 5, processor subsystem 520 may include an integrated circuit, such as in the form of a chip, for interpreting and executing program instructions and process data. Processor subsystem 520 may include a general-purpose processor configured to execute program code accessible to processor subsystem 520. Processor subsystem 520 may include a special purpose processor in which certain instructions are incorporated into processor subsystem 520. Processor subsystem 520 may represent a single processor or multiple processors working together in compute node 500. Processor subsystem 520 may also represent multiple different kinds of processors, such as processors used for different types of tasks, including CPUs and GPUs used in compute node 500. Furthermore, processor subsystem 520 may include multiple cores or micro-cores for executing program code or handling different processes. In some implementations, processor subsystem 520 may interpret and execute program instructions and process data stored locally (e.g., in memory 530). In particular implementations, processor subsystem 520 may interpret and execute program instructions and process data stored remotely (e.g., in a network storage resource accessible using network interface 560).

In FIG. 5, system bus 522 may represent a variety of suitable types of bus structures, e.g., a memory bus, a peripheral bus, or a local bus using various bus architectures in selected implementations.

Also in FIG. 5, memory 530 may include a system, device, or apparatus operable to retain and retrieve program instructions and data for a period of time (e.g., computer-readable media). Memory 530 may include volatile memory such as RAM, a cache memory, magnetic memory, among others. In some implementations, memory 530 include any of various non-volatile memory that retains data after power is removed, such as a hard disk, an optical drive such as a compact disk (CD) drive or digital versatile disk (DVD) drive, a flash memory, electrically erasable programmable read-only memory (EEPROM), a memory card, a magnetic storage, an opto-magnetic storage, among others. Memory 530 may also include or represent a computer-readable medium that includes, but is not limited to, portable or non-portable storage devices, optical storage devices, and various other mediums capable of storing, containing, or carrying instruction(s) and/or data. The computer-readable medium may include a non-transitory medium that stores data and does not include carrier waves and/or transitory electronic signals propagating wirelessly or over wired connections. The computer-readable medium may store code and/or processor-executable instructions that may represent a procedure, a function, a subprogram, a program, a routine, a subroutine, a module, a software package, a class, or any combination of instructions, data structures, or program statements, among other examples.

In FIG. 5, memory 530 is shown including an operating system (OS) 532, which may represent an execution environment for various program code executing on compute node 500. OS 532 may be any of a variety of standard or customized operating systems, such as but not limited to a Microsoft Windows® operating systems, a UNIX or a UNIX-based operating system, a mobile device operating system (e.g., Google Android™ platform, Apple® iOS, among others), an Apple® MacOS operating system, an embedded operating system, among others. Memory 530 is also shown including a migration agent 504 that can represent at least certain portions of migration agent 120, described above with respect to FIGS. 1 and 3.

In compute node 500, I/O subsystem 540 may include a system, device, or apparatus generally operable to receive and transmit data to or from or internally within compute node 500. In different implementations, I/O subsystem 540 may be used to support various peripheral devices, such as a touch panel, a display adapter, a keyboard, a touch pad, or a camera, among other examples. I/O subsystem 540 may represent, for example, a variety of communication interfaces, graphics interfaces, video interfaces, user input interfaces, and peripheral interfaces. For example, I/O subsystem 540 may support various output or display devices, such as a screen, a monitor, a general display device, a liquid crystal display (LCD), a plasma display, a touchscreen, a projector, a printer, an external storage device, or another output device. In some instances, I/O subsystem 540 can support multimodal systems that allow a user to provide multiple types of I/O to communicate with compute node 500.

In FIG. 5, local storage resource 550 may comprise non-volatile or persistent computer-readable media such as a hard disk drive, CD-ROM, and other type of rotating storage media, flash memory, EEPROM, or another type of solid state storage media, and may be generally operable to store instructions and data, and to permit access to stored instructions and data on demand. In some implementations, local storage resource 550 may include a storage appliance or a storage subsystem having one or more arrays of storage devices, such as for supporting redundancy, mirroring, and/or real-time data error correction and restoration.

Further, in FIG. 5, network interface 560 may facilitate connecting compute node 500 to network 570, which may represent a local area network (LAN), a wide area network (WAN) such as the Internet, mobile network, or another type of network. Network interface 560 can provide communication with another device, such as another computing node. Network interface 560 may include or support wireless networks or wired networks. The wired network media supported by network interface 560 may include analog media, universal serial bus (USB), Apple® Lightning®, Ethernet, fiber optics, a proprietary wired media, Public Switched Telephone Network (PSTN), Integrated Services Digital Network (ISDN), and an ad-hoc network media, among others. The wireless network media supported by network interface 560 may include Visible Light Communication (VLC), Worldwide Interoperability for Microwave Access (WiMAX), a Bluetooth® wireless signal transfer, a BLE wireless signal transfer, an IBEACON® wireless signal transfer, a RFID wireless signal transfer, near-field communications (NFC) wireless signal transfer, dedicated short range communication (DSRC) wireless signal transfer, 802.11 WiFi wireless signal transfer, WLAN signal transfer, IR communication wireless signal transfer, 3G/4G/5G/LTE cellular data network wireless signal transfer, radio wave signal transfer, microwave signal transfer, infrared signal transfer, visible light signal transfer, ultraviolet light signal transfer, wireless signal transfer along the electromagnetic spectrum, among others.

As shown in FIG. 5, network interface 560 may also include one or more Global Navigation Satellite System (GNSS) receivers or transceivers that are used to determine a location of computing node 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. In particular implementations, network interface 560 can support expansion or addition of new network interfaces or media.

At least certain portions of compute node 500 may be implemented in circuitry. For example, the components of compute node 500 can include electronic circuits or other electronic hardware, which can include a programmable electronic circuit, a microprocessor, a graphics processing unit (GPU), a digital signal processor (DSP), a central processing unit (CPU), along with other suitable electronic circuits. Certain functionality incorporated into compute node 500 may be provided using executable code that is accessible to an electronic circuit, as described above, including computer software, firmware, program code, or various combinations thereof, to perform the methods and operations described herein. When specified, non-transitory media expressly exclude transitory media such as energy, carrier signals, light beams, and electromagnetic waves.

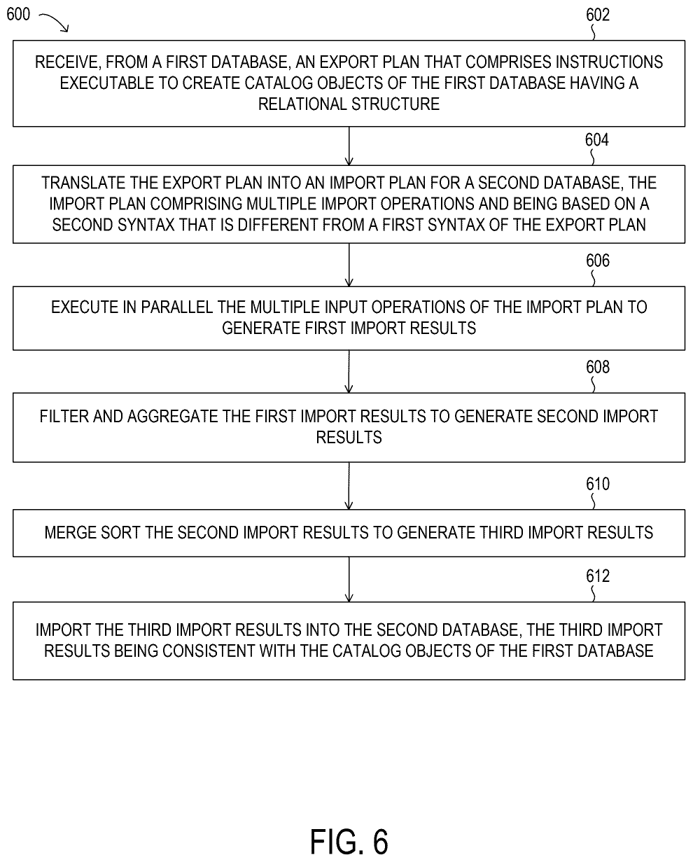

FIG. 6 is a flowchart of a method 600 for database migration, in an example. Method 600 may be a computer-implemented method performed using migration agent 120, 404, 504 in various implementations. Various operations in method 600 may be rearranged or omitted in various cases.

Method 600 begins at step 602. At step 602, an export plan is received, from a first database, that comprises instructions executable to create catalog objects of the first database having a relational structure. The first database may be a SQL database implemented in a SQL database system. The catalog objects may include or describe a catalog, a schema, a table, a view, a procedure, a sequence, a function, or a trigger of the first database.

At step 604, the export plan is translated into an import plan for a second database, the import plan comprising multiple import operations and being based on a second syntax that is different from a first syntax of the export plan. The first syntax can be SQL, while the second syntax can be compatible with a non-relational structure supported by the second database.

At step 606, the multiple input operations of the import plan are executed in parallel to generate first import results. At step 606, at least some of the catalog objects may be divided into subsets based on index value ranges, wherein each of the subsets is used for an import operation of the multiple import operations. Step 606 may include respectively executing, for each of the subsets, the import operations of the multiple import operations in parallel.

At step 608, the first import results are filtered and aggregated to generate second import results. The second import results may be unjoined with respect to index values. At step 610, the second import results are merge sorted to generate third import results. The third import results may be joined with respect to the index values

At step 612, the third import results are imported into the second database, the third import results being consistent with the catalog objects of the first database. After step 612, first results may be received, from the second database, to a first query associated with the catalog objects consistent with second results to a second query of the first database, the second query being commensurate to the first query.

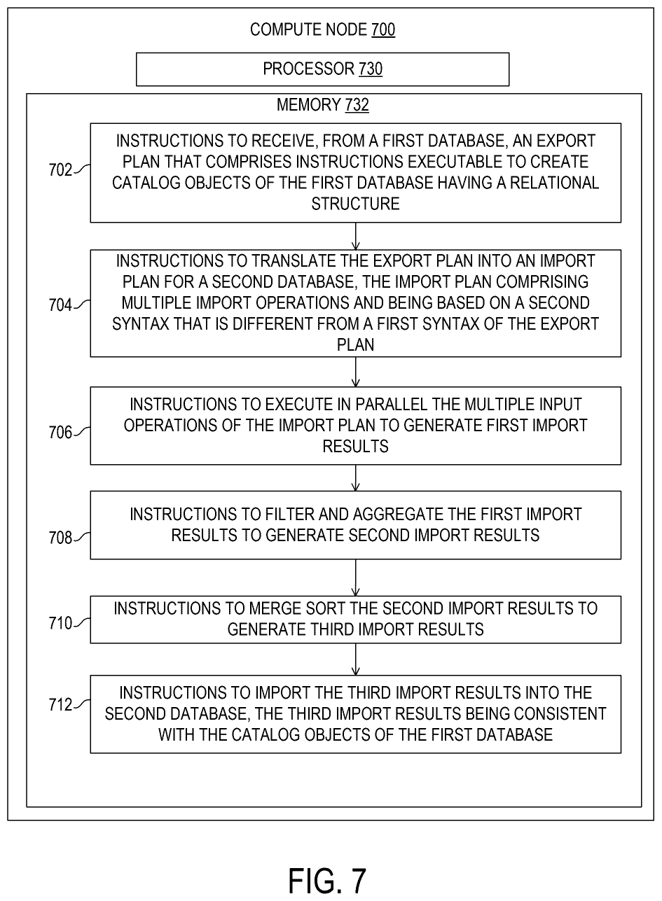

FIG. 7 is a block diagram of a compute node 700, according to certain implementations. Compute node 700 is an example of compute node 500 previously described for FIG. 5. Compute node 700 may include one or more processors 730 and memory 732. Memory 732 may include a non-transitory computer-readable medium that stores programming for execution by one or more of the one or more processors 730. In this implementation, one or more modules within compute node 700 may be partially or wholly embodied as software for performing any functionality described in this disclosure.

For example, memory 732 may include instructions 702 to receive, from a first database, an export plan that comprises instructions executable to create catalog objects of the first database having a relational structure. Memory 732 may include instructions 704 to translate the export plan into an import plan for a second database, the import plan comprising multiple import operations and being based on a second syntax that is different from a first syntax of the export plan. Memory 732 may include instructions 706 to execute in parallel the multiple input operations of the import plan to generate first import results. Memory 732 may include instructions 708 to filter and aggregating the first import results to generate second import results. Memory 732 may include instructions 710 to merge sort the second import results to generate third import results. Memory 732 may include instructions 712 to import the third import results into the second database, the third import results being consistent with the catalog objects of the first database.

As described herein, in certain implementations, an export plan is received, from a first database, that comprises instructions executable to create catalog objects of the first database having a relational structure. The export plan may be translated into an import plan for a second database, the import plan comprising multiple import operations and being based on a second syntax that is different from a first syntax of the export plan. The multiple input operations of the import plan may be executed in parallel to generate first import results. The first import results may be filtered and aggregated to generate second import results. The second import results may be merge sorted to generate third import results. The third import results may be imported into the second database, the third import results being consistent with the catalog objects of the first database.

The foregoing outlines features of several examples so that those skilled in the art may better understand the aspects of the present disclosure. Various modifications and combinations of the illustrative examples, as well as other examples, are contemplated in the description.

1. A computer-implemented method, comprising:
receiving, from a first database, an export plan that comprises instructions executable to create catalog objects of the first database having a relational structure;
translating the export plan into an import plan for a second database, the import plan comprising multiple import operations and being based on a second syntax that is different from a first syntax of the export plan;
executing in parallel the multiple import operations of the import plan to generate first import results;
filtering and aggregating the first import results to generate second import results;
merge sorting the second import results to generate third import results; and
importing the third import results into the second database, the third import results being consistent with the catalog objects of the first database.

2. The computer-implemented method of claim 1, wherein executing in parallel the multiple import operations of the import plan comprises:
dividing at least some of the catalog objects into subsets based on index value ranges, wherein each of the subsets is used for an import operation of the multiple import operations.

3. The computer-implemented method of claim 2, wherein executing in parallel the multiple import operations of the import plan comprises:
respectively executing, for each of the subsets, the multiple import operations of the multiple import operations in parallel.

4. The computer-implemented method of claim 1, wherein:
the second import results are unjoined with respect to index values; and
the third import results are joined with respect to the index values.

5. The computer-implemented method of claim 1, wherein:
the first syntax is structured query language (SQL); and
the second syntax is compatible with a non-relational structure supported by the second database.

6. The computer-implemented method of claim 1, further comprising:
receiving, from the second database, first results to a first query associated with the catalog objects consistent with second results to a second query of the first database, the second query being commensurate to the first query.

7. The computer-implemented method of claim 1, wherein the catalog objects in the import plan include at least one of: a catalog; a schema; a table; a view; a procedure; a sequence; a function; or a trigger.

8. A computer system, comprising:
memory media storing programming for execution by one or more processors; and
one or more processors configured to access the memory media for execution of the programming to:
receive, from a first database, an export plan that comprises instructions executable to create catalog objects of the first database having a relational structure;
translate the export plan into an import plan for a second database, the import plan comprising multiple import operations and being based on a second syntax that is different from a first syntax of the export plan;
execute in parallel the multiple import operations of the import plan to generate first import results;
filter and aggregating the first import results to generate second import results;
merge sort the second import results to generate third import results; and
import the third import results into the second database, the third import results being consistent with the catalog objects of the first database.

9. The computer system of claim 8, wherein the programming to execute in parallel the multiple import operations of the import plan comprises programming to:
divide at least some of the catalog objects into subsets based on index value ranges, wherein each of the subsets is used for an import operation of the multiple import operations.

10. The computer system of claim 9, wherein the programming to execute in parallel the multiple import operations of the import plan comprises programming to:
respectively execute, for each of the subsets, the multiple import operations in parallel.

11. The computer system of claim 8, wherein:
the second import results are unjoined with respect to index values; and
the third import results are joined with respect to the index values.

12. The computer system of claim 8, wherein:
the first syntax is structured query language (SQL); and
the second syntax is compatible with a non-relational structure supported by the second database.

13. The computer system of claim 8, further comprising programming to:
receive, from the second database, first results to a first query associated with the catalog objects consistent with second results to a second query of the first database, the second query being commensurate to the first query.

14. The computer system of claim 8, wherein the catalog objects in the import plan include at least one of: a catalog; a schema; a table; a view; a procedure; a sequence; a function; or a trigger.

15. Non-transitory computer-readable media storing programming for execution by one or more processors, the programming comprising instructions to:
receive, from a first database, an export plan that comprises instructions executable to create catalog objects of the first database having a relational structure;
translate the export plan into an import plan for a second database, the import plan comprising multiple import operations and being based on a second syntax that is different from a first syntax of the export plan;
execute in parallel the multiple import operations of the import plan to generate first import results;
filter and aggregating the first import results to generate second import results;
merge sort the second import results to generate third import results; and
import the third import results into the second database, the third import results being consistent with the catalog objects of the first database.

16. The non-transitory computer-readable media of claim 15, wherein the instructions to execute in parallel the multiple import operations of the import plan comprise instructions to:
divide at least some of the catalog objects into subsets based on index value ranges, wherein each of the subsets is used for an import operation of the multiple import operations.

17. The non-transitory computer-readable media of claim 16, wherein the instructions to execute in parallel the multiple import operations of the import plan comprise instructions to:
respectively execute, for each of the subsets, the multiple import operations in parallel.

18. The non-transitory computer-readable media of claim 15, wherein:
the second import results are unjoined with respect to index values;
the third import results are joined with respect to the index values;
the first syntax is structured query language (SQL); and
the second syntax is compatible with a non-relational structure supported by the second database.

19. The non-transitory computer-readable media of claim 15, further comprising instructions to:
receive, from the second database, first results to a first query associated with the catalog objects consistent with second results to a second query of the first database, the second query being commensurate to the first query.

20. The non-transitory computer-readable media of claim 15, wherein the catalog objects in the import plan include at least one of: a catalog; a schema; a table; a view; a procedure; a sequence; a function; or a trigger.
